(19) United States
(12) Patent Application Publication
(10) Pub. No.: US 2005/0041532 A1
(43) Pub. Date: Feb. 24, 2005

(54) Electronic device having stopwatch and heat index indicator functionality

(76) Inventor: Gerald W. Blakeley III, Lincoln, MA (US)

Correspondence Address: Brian M. Dingman, Esq.;Mirick, O'Connell, DeMallie & Lougee, LLP, 1700 West Park Drive, Westborough, MA, 01581-3941, US

(21) Appl. No.: 10/922,257

(22) Filed: Aug. 19, 2004

Related U.S. Application Data
(60) Provisional application No. 60/496,809, filed on Aug. 21, 2003.

(51) Int. Cl. G04B 47/06; B32B 3/02

(52) U.S. Cl. 368/11

(57) ABSTRACT

An electronic device including a multimode electronic stopwatch having a digital display and programmable integrated circuit programmed to keep time and to provide a plurality of timepiece operating modes. The device includes a humidity sensor for acquiring relative humidity information, and a temperature sensor for acquiring ambient temperature information. The integrated circuit also determines a heat index value based on the temperature and humidity information. The device has a display for displaying to the user the determined heat index value, and an alarm for notifying the user when a particular heat index level is reached.

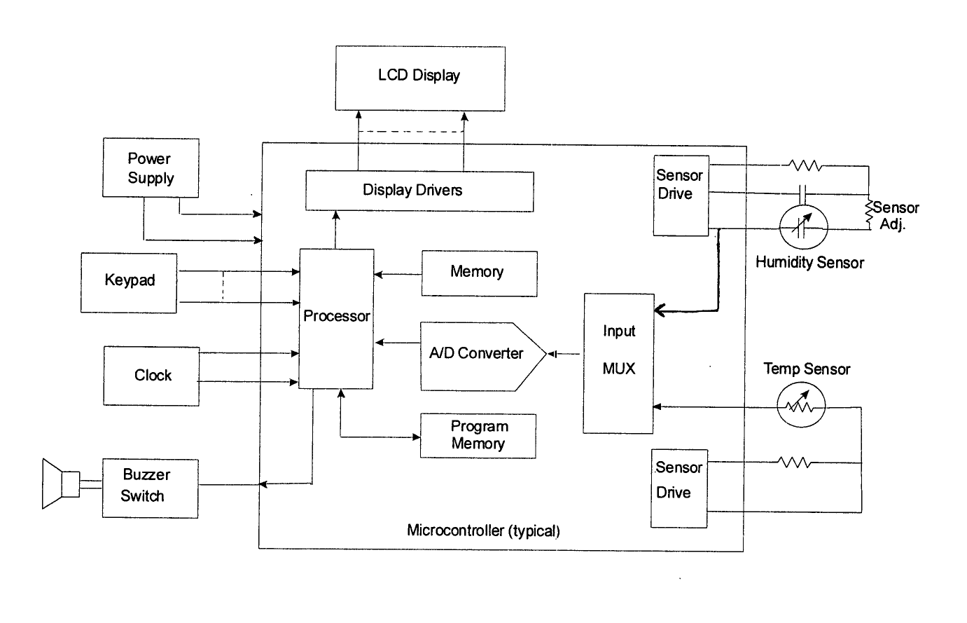

### CROSS REFERENCE TO RELATED APPLICATIONS

This application claims priority of Provisional application Ser. No. 60/496,809, filed on Aug. 21, 2003.

### FIELD OF THE INVENTION

The invention relates generally to multimode digital electronic timepieces such as stopwatches that display date, time and stopwatch information, and more particularly to a timepiece capable of displaying temperature, humidity and heat index information and providing a user alarm when the heat index reaches a level preset by the user.

### BACKGROUND OF THE INVENTION

Present methods of determining the heat index (HI) require cumbersome equipment such as a sling psychrometer and a thermometer to measure the relative humidity (RH) and temperature, respectively, and at least tables to determine the HI. Also, using these methods it is not possible to continuously monitor the HI easily.

### SUMMARY OF THE INVENTION

It is therefore a primary object of this invention to provide a handheld instrument that includes the functionality of a stopwatch and also determines and reports to the user the heat index, preferably along with an alarm that notifies the user when a particular preset heat index is reached.

Since many outdoor activities that require high levels of physical activity also require the use of a stopwatch, the invention overcomes the problems noted above without using any additional or bulky equipment and can display the HI on the same device used to time the activities taking place.

This invention features a portable device or unit that includes an accurate electronic digital stopwatch and a heat index indicator that may include a user settable audible warning alarm. When in the heat index mode the unit determines and displays ambient temperature (in ° C. or ° F.) and humidity (RH %) readings gathered by sensors mounted in the case of the unit. The unit uses these readings to compute and display a heat index (HI) value. It also has a user settable audible alarm that is activated when the user-set heat index value is reached. The stopwatch performs the usual stopwatch functions such as lap time, split time, and countdown time, each being accessed through predetermined push button sequences of a keypad.

Heat Index Calculation Procedure

The computation used for the heat index is preferably a refinement of a result obtained by multiple regression analysis carried out by Lans P. Rothfusz and described in a 1990 National Weather Service (NWS) Technical Attachment (SR 90-23). The regression equation of Rothfusz is:
HI=−42.379+2.04901523*T+10.14333127*RH−0.22475541*T*RH−0.00683783*T*T−0.05481717*RH*RH+0.00122874*T*T*RH+0.00085282*T*RH*RH−0.00000199*T*T*RH*RH
where T is temperature in degrees F. and RH is relative humidity in percent. HI is the heat index expressed as an apparent temperature in degrees F. If the RH is less than 13% and the temperature is between 80 and 112 degrees F., then the following adjustment is subtracted from HI:
ADJUSTMENT=[(13−RH)/4]*SQRT{[17−ABS(T−95.)]/17}
where ABS and SQRT are the absolute value and square root functions, respectively.

On the other hand, if the RH is greater than 85% and the temperature is between 80 and 87 degrees F., then the following adjustment is added to HI:
ADJUSTMENT=[(RH−85)/10]*[(87−T)/5]

An alternate method is to refer to readily available tables listing the HI for specific temperatures and RH. The data from these tables can be stored in the memory of the inventive instrument, for example in a look-up table that is used to determine the HI. These tables can also indicate to the user the severity of exposure to a specific HI.

Heat Index/Heat Disorders

Heat Index / Heat Disorders

| Heat | Possible heat disorders for |
|---|---|
| Index | people in higher risk groups |
| 130° F. or | Heatstroke/sunstroke highly likely with continued |
| higher | exposure. |
| 105°- | Sunstroke, heat cramps or heat exhaustion likely, and |
| 130° F. | heatstroke possible with prolonged exposure and/or |
| | physical activity. |
| 90°- | Sunstroke, heat cramps and heat exhaustion possible |
| 105° F. | with prolonged exposure and/or physical activity. |
| 80°- | Fatigue possible with prolonged exposure and/or |
| 90° F. | physical activity. |

The “Heat Index/Heat Disorders” table relates ranges of HI with specific disorders, particularly for people in the higher risk groups.

This invention features an electronic device including a multimode electronic stopwatch having a digital display and programmable integrated circuit programmed to keep time and to provide a plurality of stopwatch operating modes, comprising a humidity sensor for acquiring relative humidity information, and a temperature sensor for acquiring ambient temperature information. The integrated circuit determines a heat index value based on the temperature and humidity information. This can be done by calculation, or using the temperature and humidity to access the correct HI data from a lookup table. The electronic device may then further include a display for displaying to the user the determined heat index value.

The electronic device may further or alternatively comprise a user alarm for notifying the user when a particular heat index level is reached. The alarm may be audible, visible, and/or may be vibrating. Preferably, this preset heat index level can be set by the user. Alternatively, it can be fixed. The electronic device may further comprise a user alarm for notifying the user when a particular humidity and/or temperature is reached. The electronic device preferably includes a display for displaying to the user the relative humidity and/or the ambient temperature.

Also featured in the invention is an electronic device including a multimode electronic stopwatch having a digital display and an integrated circuit that keeps time and provides a plurality of timepiece operating modes, comprising a humidity sensor for acquiring relative humidity information, and a temperature sensor for acquiring ambient temperature information. The integrated circuit determines a heat index value based on the temperature and humidity information. There is a display for displaying to the user the determined heat index value, and a user alarm for notifying the user when a particular heat index level is reached. In this embodiment, the particular heat index level can be set by the user. The alarm may be audible, visible, and/or vibrating.

### BRIEF DESCRIPTION OF THE DRAWING

Other objects, features and advantages will occur to those skilled in the art from the following description of the preferred embodiment and the accompanying drawing, which is a schematic block diagram of the preferred embodiment of the inventive electronic device having both the stopwatch and heat index indicator functionality.

### DETAILED DESCRIPTION OF THE PREFERRED EMBODIMENT

The following description is of the preferred embodiment of the invention, shown in the attached FIGURE. It consists of a microcontroller that includes any necessary analog-to-digital converters, display drivers, keypad interface, functional program, memory, microprocessor calculating capability, and alarm driver. There are many other embodiments that would be obvious to anyone knowledgeable in these areas. In many cases, the functions included in the microcontroller could instead be performed by individual external devices. The LCD display in this embodiment can be replaced by other display technology such as LEDs. The device has typical stopwatch functionality as described above, the details of which are known in the art.

The power supply provides power for the microcontroller and all other devices as required. The keypad is used to step through the various functions, input the HI alarm setpoint, set up the parameters (such as ° C. or ° F.), and determine the display mode (e.g., stopwatch, temperature, humidity, or heat index (which typically also displays the temperature and RH)). The clock is used to provide all the timing functions and step through the program. There is a memory for the program and a secondary memory to store values and functions that are subject to change during setup or use.

The humidity sensor illustrated here is a capacitive type, but other types will also work. The sensor output is converted to a digital value by the microcontroller and displayed on the LCD. The temperature sensor is a thermistor type, but once again any suitable type will also work. Its output is also converted to a digital value by the microcontroller and also displayed on the LCD.

The humidity and temperature values are combined by the microcontroller to calculate the heat index, which is also displayed on the LCD. The user can use the keypad to enter a HI alarm setpoint value. If this value is exceeded, a signal drives the buzzer switch that activates the audible buzzer or other type (e.g. visible or vibrating) user alarm/warning device.

Although specific features of the invention are shown in the drawing, this is not a limitation of the invention, as the claims set forth the rights granted under the patent. Other combinations of features would be apparent to those skilled in the field and are within the scope of the claims.

1. An electronic device including a multimode electronic stopwatch having a digital display and an integrated circuit that keeps time and provides a plurality of stopwatch operating modes, comprising a humidity sensor for acquiring relative humidity information.

2. The electronic device of claim 1, further comprising a temperature sensor for acquiring ambient temperature information.

3. The electronic device of claim 2, wherein the integrated circuit determines a heat index value based on the temperature and humidity information.

4. The electronic device of claim 3, further comprising a display for displaying to the user the determined heat index value.

5. The electronic device of claim 3, further comprising a user alarm for notifying the user when a particular heat index level is reached.

6. The electronic device of claim 5, wherein the particular heat index level can be set by the user.

7. The electronic device of claim 5, wherein the alarm is audible.

8. The electronic device of claim 5, wherein the alarm is visible.

9. The electronic device of claim 5, wherein the alarm is a vibrating alarm.

10. The electronic device of claim 1, further comprising a user alarm for notifying the user when a particular humidity is reached.

11. The electronic device of claim 2, further comprising a user alarm for notifying the user when a particular ambient temperature is reached.

12. The electronic device of claim 1, further comprising a display for displaying to the user the relative humidity.

13. The electronic device of claim 2, further comprising a display for displaying to the user the ambient temperature.

14. An electronic device including a multimode electronic stopwatch having a digital display and an integrated circuit that keeps time and provides a plurality of stopwatch operating modes, comprising:
a humidity sensor for acquiring relative humidity information;
a temperature sensor for acquiring ambient temperature information;
wherein the integrated circuit determines a heat index value based on the temperature and humidity information;
a display for displaying to the user at least the determined heat index value; and
a user alarm for notifying the user when a particular heat index level is reached.

15. The electronic device of claim 14, wherein the particular heat index level can be set by the user.

16. The electronic device of claim 14, wherein the alarm is audible.

17. The electronic device of claim 14, wherein the alarm is visible.

18. The electronic device of claim 14, wherein the alarm is a vibrating alarm.
